(19) United States
(12) Patent Application Publication
(10) Pub. No.: US 2008/0270226 A1
(43) Pub. Date: Oct. 30, 2008

(54) ELECTRONIC TOLL COLLECTION AND RENTAL VEHICLES

(76) Inventor: Robert J. Archibald, Wall, NJ (US)

Correspondence Address: KEATING & BENNETT, LLP, 1800 Alexander Bell Drive, SUITE 200, Reston, VA, 20191, US

(21) Appl. No.: 11/832,101

(22) Filed: Aug. 1, 2007

Related U.S. Application Data
(60) Provisional application No. 60/950,464, filed on Jul. 18, 2007.
(60) Provisional application No. 60/915,105, filed on Apr. 30, 2007.

(51) Int. Cl. G06Q 30/00

(52) U.S. Cl. 705/13

(57) ABSTRACT

A method of calculating a usage fee for the use of electronic toll collection in a rental vehicle includes collecting customer information concerning customer's renting of one or more rental vehicles, collecting toll use information concerning the use of electronic toll collection at a tollgate, calculating a usage fee based upon the customer information and the toll use information, and displaying the usage fee.

### BACKGROUND OF THE INVENTION

1. Field of the Invention

The present invention relates to electronic toll collection. More specifically, the present invention relates to electronic toll collection for rental vehicles or fleet vehicles.

2. Description of the Related Art

It is known to collect tolls from vehicles driving on roads or bridges. Tollgates are located at various points along the road or the bridge to collect tolls. These tolls are paid to a Toll Collector. Toll Collector, as used herein, means any state or private agency, company, or organization that collects tolls.

It is also known to electronically collect tolls. Tollgates can electronically collect tolls by using reader equipment, which usually includes an antenna that electronically communicates with an RFID (“Radio Frequency IDentification”) transponder located in the vehicle. The reader equipment of the tollgate collects identifying information from the RFID transponder so that the owner of the RFID transponder can be billed for the toll later.

A well known electronic toll collection system is the E-ZPass system. A person, company, or organization can use an E-ZPass RFID transponder provided by a state agency that is responsible for electronic toll collection. Because several states use the same technology to electronically collect tolls, users of the E-ZPass system can use their E-ZPass RFID transponders in any of the several states that use the E-ZPass system. Each E-ZPass RFID transponder is typically registered to a single vehicle. Typically, the person, company, or organization pre-pays with a credit card a certain amount into an account with the state agency for electronic toll collection through the E-ZPass system, and when the account falls below a certain amount, the state agency charges the credit card the certain amount again.

Until now, rental vehicle customers could not easily use electronic toll collection because many states have laws that make it illegal to use an RFID transponder in a vehicle that the RFID transponder is not registered to and because Rental Vehicle Agencies were reluctant to provide their customers with RFID transponders. Rental Vehicle Agencies were reluctant to provide their customers with RFID transponders for, at least the following reasons:
1. Rental Vehicle Agencies do not want to own and service the third party RFID transponders required for Electronic Toll Collection.
2. Rental Vehicle Agencies lack a system for installing, tracking, and monitoring the RFID transponders.
3. Rental Vehicle Agencies are generally unwilling to risk the liability of lost or stolen devices, which have the potential of incurring substantial unauthorized charges.
4. Rental Vehicle Agencies lack a system where toll charges incurred during a rental period could be billed to a customer in a timely fashion. Rental Vehicle Agencies have developed sophisticated handheld technologies which enable curbside close-out of the rental agreement at the precise time that a vehicle is returned, which is considered a competitive advantage. Toll charges, however, can take weeks to process, and the Rental Vehicle Agencies typically avoid any program that would require post or additional credit card billing of the customer because of the potential customer backlash.
5. Rental Vehicle Agencies do not wish to stray from their core competency by adding additional layers of complexity and bureaucracy to their business models.
6. Traditionally, Rental Vehicle Agencies have viewed Electronic Toll Collection as a cost center rather than a revenue center.

Rental Vehicle Agency or Company, as used herein, means any company or organization that rents or leases any type of vehicle that can use toll roads or toll bridges, including cars, motorcycles, trucks, tractor trailers, recreational vehicles, or any other vehicle that can use toll roads or toll bridges. Further, vehicle, as used herein, includes cars, motorcycles, trucks, tractor trailers, recreational vehicles, or any other vehicle that can use toll roads or toll bridges.

### SUMMARY OF THE INVENTION

The present inventor has formed a company (hereinafter referred to as “Third-Party Company”) whose business model includes using the preferred embodiments of the present invention, which offer at least one of the following benefits:
1. Third-Party Company owns all Electronic Toll Devices (typically an RFID transponder) and provides the Electronic Toll Devices at no cost to the Rental Vehicle Agencies. However, it is also possible that that Rental Vehicle Company owns all or a portion of the Electronic Toll Devices.
2. Third-Party Company offers several installation/transaction models that provide simple easy-to-follow installation and de-installation procedures.
3. Although the rental vehicle Customer is held responsible for returning the Electronic Toll Devices when the rental vehicle is returned, Third-Party Company assumes ultimate responsibility for lost or stolen the Electronic Toll Devices, as well as unauthorized usage. Third-Party Company can immediately replace missing Electronic Toll Devices, regardless of the reason.
4. Using Third-Party Company's Electronic Toll Information Analyzer, the Third-Party Company can easily determine the toll charges and usage fees that will be charged to the Customer's credit card with the Rental Vehicle Company or the Third-Party Company as the payee. Preferably, the Third-Party Company is the payee in order to minimize the responsibilities of the Rental Vehicle Company.
5. Third-Party Company can coordinate, manage, and direct all aspects of the Electronic Toll Collection process, leaving the Rental Vehicle Agencies to concentrate on their core competency.
6. The Third-Party Company's model will provide a lucrative revenue center for the Rental Vehicle Company.

Of course, it is also possible that a Rental Vehicle Company will adopt all or a portion of this business model. That is, the preferred embodiments of the present invention are not limited to a company separate from the Rental Vehicle Company and can be practiced by a Rental Vehicle Company.

Other features, elements, characteristics and advantages of the present invention will become more apparent from the following detailed description of preferred embodiments of the present invention with reference to the attached drawings.

### BRIEF DESCRIPTION OF THE DRAWING

FIG. 1 is a diagram showing the various interactions of the components according to preferred embodiments of the present invention.

FIG. 2 is a flowchart showing an example of the preferred embodiments of the present invention.

### DETAILED DESCRIPTION OF PREFERRED EMBODIMENTS

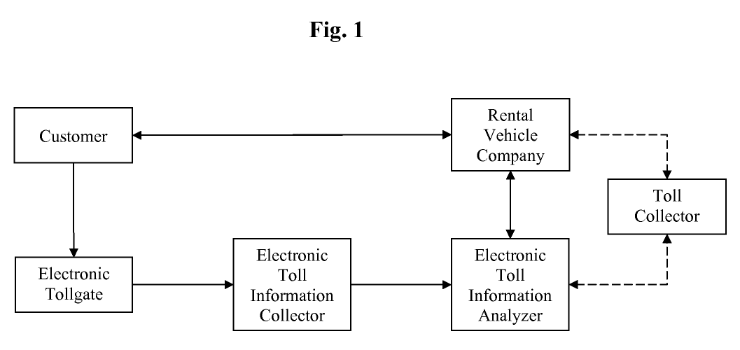

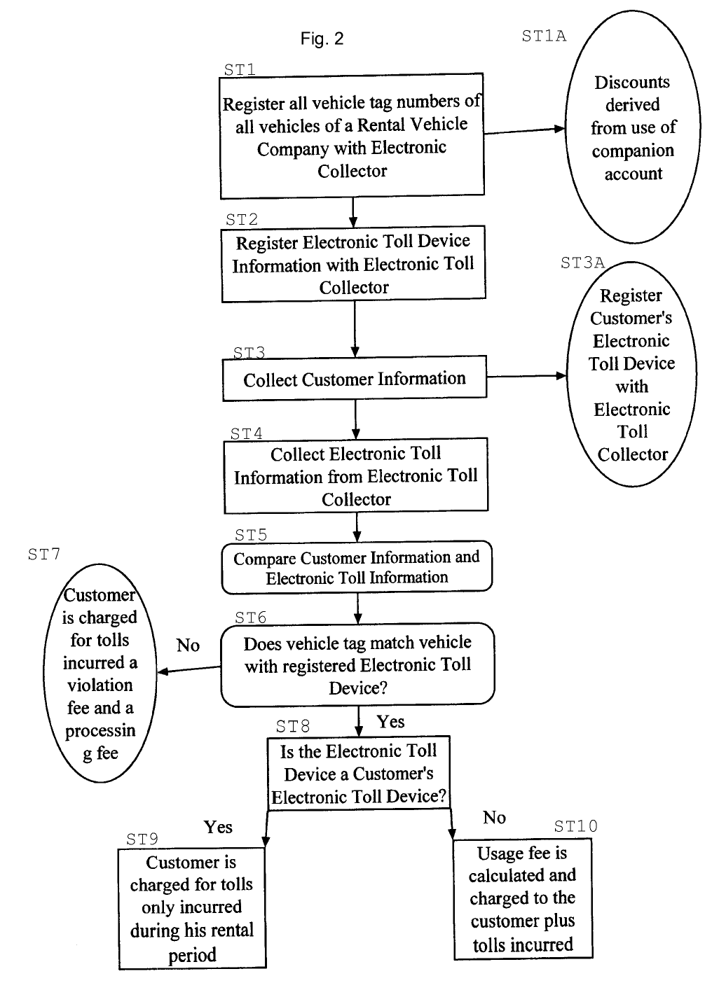

The preferred embodiments of the present invention are discussed with respect to FIGS. 1 and 2. FIG. 1 shows the interactions between a Customer, a Rental Vehicle Company, an Electronic Tollgate, an Electronic Toll Information Collector, an Electronic Toll Information Analyzer, and a Toll Collector. FIG. 2 is a flowchart showing an example of the preferred embodiments of the present invention.

### Rental Vehicle Company

When the Customer rents a vehicle or vehicles at the Rental Vehicle Company, the Rental Vehicle Company will give the Customer the option of using Electronic Toll Collection. This option is usually presented as part of the rental agreement, but it could also be presented in a separate contract. Of course, it is also possible that the Rental Vehicle Company, e.g., in toll road or toll bridge dense areas, does not offer the use an Electronic Toll Collection as an option, but instead makes the use of an Electronic Toll Collection a condition of renting the vehicle or vehicles.

Different pricing schemes for using the Electronic Toll Collection can be used. The Rental Vehicle Company can charge a usage fee for using the Electronic Toll Collection. For example, for the usage fee, the Rental Vehicle Company could charge a fixed daily rate, a per use fee, a fixed fee for the duration of the rental agreement, or any other suitable pricing schemes. The usage fee can be fixed to include all of the toll fees or can be variable to include a fixed fee in addition to the toll fees. That is, if the usage fee is fixed, the Customer will be billed the same usage fee no matter how much toll fees are billed during the Electronic Toll Collection rental period. A benefit of a fixed usage fee is that the Customer will know the total charge to be paid to the Rental Vehicle Company when the Customer returns the rental vehicle. However, it is possible that the fixed usage fee will be less than the total toll fees billed during the Electronic Toll Collection rental period.

As part of the agreement to use the Electronic Toll Collection, the Customer can agree that their credit card will be charged for the usage fee, and possibly the toll fees, with the Rental Vehicle Company or the Third-Party Company as the payee. If the Customer does not have a credit card or prefers to pay with cash, then it is preferable to use a pricing scheme where a fixed usage fee includes the toll fees so that all of the fees can be determined at the time of the rental of the vehicle. However, the Customer could also agree to be billed at a later time for the toll fees.

The usage fee can be split between the Rental Vehicle Company and the Third-Party Company. This split of the usage fee should be agreed upon prior to the collecting of the usage fee. Of course, this split between the Rental Vehicle Company and the Third-Party Company can be changed. The Rental Vehicle Company could also keep the entire usage fee.

Typically, the Third-Party Company owns the Electronic Toll Devices and will provide an Electronic Toll Device for use in Electronic Toll Collection to the Rental Vehicle Company to provide to the Customer. It is also possible that the Rental Vehicle Company owns the Electronic Tolls Devices. No matter who owns the Electronic Toll Device, the Electronic Toll Device will need to be registered with the Electronic Toll Collector so that the Electronic Toll Devices can properly be used in the rental vehicle by the Customer.

Instead of using an Electronic Toll Device, it is also possible to use other suitable devices, e.g., the vehicle tag or the Customer's Electronic Toll Device, for Electronic Toll Collection. If the vehicle tag is used in Electronic Toll Collection, the vehicle tag number is electronically determined during Electronic Toll Collection. If the Customer's Electronic Toll Device is used in Electronic Toll Collection, the Rental Vehicle Company collects information concerning the Customer's Electronic Toll Device so that the Customer's Electronic Toll Device can be registered with the Electronic Toll Collector with respect to the rental vehicle, which is important in order to comply with all state laws.

If an Electronic Toll Device is used, then the Rental Vehicle Company can equip each vehicle or a portion of the vehicles with an Electronic Toll Device so that each Electronic Toll Device is associated with a specific rental vehicle during the lifetime of the Electronic Toll Device, or the Rental Vehicle Company can associate the Electronic Toll Devices at the time of rental such that the Electronic Toll Device can be associated with different rental vehicles during the lifetime of the Electronic Toll Device.

The Electronic Toll Device can be an RFID transponder or any other suitable device that can be used with Electronic Toll Collection. The Electronic Toll Device can be attached to the rental vehicle in any manner, including permanently attached, semi-permanently attached, or removably attached to the rental vehicle. If the device is permanently attached to the rental vehicle, then some mechanism should be provided such that the Electronic Toll Device is disabled if the Customer chooses not to use the Electronic Toll Device. The Electronic Toll Device can be semi-permanently attached to the rental vehicle by double-sided tape or any other suitable semi-permanent attachment method. The Electronic Toll Device can be removably attached to the rental vehicle by suction cups, fabric hook-and-loop fasteners, or any other suitable removable attachment method.

The Rental Vehicle Company electronically collects information concerning the rental transactions where the Customer has agreed to use Electronic Toll Collection provided by the Rental Vehicle Company. For example, the Rental Vehicle Company could create an electronic file with following the format, where the information type is a variable type:

| Column | Information Type |
|---|---|
| Rental ID | Text |
| Invoice # | Text |
| Contract # | Text |
| Unique Vehicle ID | Text |
| VIN | Text |
| Tag Number | Text |
| Electronic Toll | Text |
| Device Number | |
| Rental Location | Text |
| Rental Date | Date |
| Rental Time | Time |
| Rental Length | Float |
| Return Date | Text |
| Return Location | Text |

The exact format of the information, the information type, and the collected information can be varied. The information collected by the Rental Vehicle Company should identify the Customer, the device (including the Electronic Toll Device) used for Electronic Toll Collection, and the period of the vehicle rental.

Of course, this can be done in different ways. For example, the Customer can be identified by, but not limited to, the Rental ID, Invoice Number, or Contract Number. The device (including the Electronic Toll Device) used for Electronic Toll Collection can be identified by, but not limited to, a Transponder Number, Tag Number, or the Unique Vehicle ID. If the Rental Vehicle Company associates the Electronic Toll Device with a rental vehicle for the life of the Electronic Toll Device, then the Electronic Toll Device can be identified by the Tag Number or Unique Vehicle ID because of the association of the Electronic Toll Device with the rental vehicle. The period of the vehicle rental can be identified by, but not limited to, either the Rental Date and the Rental Length or the Rental Date and the Return Date.

The Rental Vehicle Company can also collect information concerning rental vehicles where a Customer has not agreed to pay the usage fee for using Electronic Toll Collection. This information can help in determining the unauthorized use of an Electronic Toll Collection, which is discussed below. The Rental Vehicle Company can also collect information concerning a portion or all of the rental vehicles owned by the Rental Vehicle Company. This information can help in determining toll violations, which is discussed below.

The Rental Vehicle Company can collect the information in a variety of ways. For example, the rental agent at the Rental Vehicle Company can manually enter the information into a computer or can electronically enter the information using, for example, a bar code reader or a magnetic stripe reader. Alternatively, for Customers who rely upon express rental where the Customer does not use a rental agent, the Customer can provide this information before picking up the rental vehicle. The Customer would typically transmit this information over the internet to the Rental Vehicle Company. However, the Customer can also provide this information to a Rental Vehicle Company operator over the telephone.

All or a portion of the information collected by the Rental Vehicle Company is transmitted to the Electronic Toll Information Analyzer, which will be described in detail below. This information transmitted to the Electronic Toll Information Analyzer is referred to as “Customer Information.”

### Electronic Toll Information Collector

When the Customer uses a toll road or toll bridge, the Customer will pass through an Electronic Tollgate, where the Customer Information is transmitted to the Electronic Tollgate. Out of all of the toll data transmitted to the Electronic Tollgate (including the Customer's Information), the Electronic Toll Information Collector collects each of the Rental Vehicle Company's Customer information.

The Electronic Toll Information Collector can be a state or private agency that is responsible for collecting tolls or that assists in the collection of tolls. The Electronic Toll Information Collector is responsible for collecting the information that is required to bill the owner of the Electronic Toll Device for the use of the toll road or toll bridge.

The Electronic Toll Information Collector electronically collects information concerning the rental vehicle Customer's use of toll roads or toll bridges. For example, the Electronic Toll Information Collector could create an electronic file with the following format, where the information type is a variable type:

| Column | Information Type |
|---|---|
| Posting Date | Data |
| Transaction Date | Date |
| Tag Number | Text |
| Electronic Toll | Text |
| Device Number | |
| Company | Text |
| Tollgate Location | Text |
| Entry Tollgate | Text |
| Entry Date | Date |
| Entry Time | Time |
| Exit Tollgate | Text |
| Exit Date | Date |
| Exit Time | Time |
| Payment Plan | Text |
| Vehicle Class | Text |
| Amount of Toll Fee | Float |

The exact format of the information, the information type, and the collected information can be varied. The information collected by the Electronic Toll Information Collector should identify the Electronic Toll Collection, amount of the toll fee, and the date of the toll collection.

This can be done in different ways. For example, the Electronic Toll Collection can be identified by, but not limited to, the Electronic Toll Device Number or the Tag Number of the rental vehicle. Typically, the Electronic Toll Device Number is collected. Instead of the Electronic Toll Device Number, the Tag Number of the rental vehicle can be collected.

The Electronic Toll Information Collector can collect the information in a variety of ways. If an Electronic Toll Device is used, the Electronic Tollgate can include an antenna that can communicate with an RFID transponder to collect the Electronic Toll Device Number. If the vehicle tag is used, the vehicle tag number can be electronically determined. Any other suitable method of electronically collecting information concerning the Electronic Toll Collection can also be used.

All or a portion of the information collected by the Electronic Toll Information Collector is transmitted to the Electronic Toll Information Analyzer, which will be described in detail below. This information transmitted to the Electronic Toll Information Analyzer is referred to as “Toll Use Information.”

### Electronic Toll Information Analyzer

The Electronic Toll Information Analyzer receives the Customer Information and the Toll Use Information. The frequency and method of transmitting the Customer Information and the Toll Use Information can be varied. For example, the information can be transmitted once a day, once a week, as soon as the information is collected, etc. The sooner that the Electronic Toll Information Analyzer receives the information the sooner that the Electronic Toll Information Analyzer can analyze the information.

Any suitable method of transmitting the Customer Information and the Toll Use Information can be used. For example, the information can be transmitted over the internet to the Electronic Toll Information Analyzer, or the information can be stored on a computer readable medium and mailed, couriered, or hand-delivered to an operator of the Electronic Toll Information Analyzer, where the operator would have to make the computer readable medium accessible to the Electronic Toll Information Analyzer so that the Electronic Toll Information Analyzer can receive the information on the computer readable medium. The Electronic Toll Information Analyzer preferably stores the Customer Information, the Toll Use Information, and the results of the analysis of this information in a database.

Analyzer, as used herein, can be any computer or combination of computers that is capable of receiving the Customer Information and the Toll Use Information and capable of analyzing that information. For example, the Electronic Toll Information Analyzer can be a personal computer, a laptop, an embedded computer, or any other suitable machine or combination of machines capable of manipulating data based upon a set of instructions. Further, the Electronic Toll Information Analyzer can display information, including any received information, any intermediate result of the analysis, and any final result of the analysis. The Electronic Toll Information Analyzer can display information either electronically (e.g., on a electronic display), non-electronically (e.g., on printed paper), or both electronically and non-electronically.

The Electronic Toll Information Analyzer can compute the total usage fee of the Customer. This is computed by matching the date of the toll fees with the dates of the Customer's rental period and summing the toll fees with matching dates.

If the Rental Vehicle Company has agreed to pay the toll fee, then the total toll fee can be transmitted to the Rental Vehicle Company so that the Rental Vehicle Company can pay the Toll Collector. If the Third-Party Company has agreed to pay the toll fee, then the Third-Party Company can use this information to pay the Toll Collector. Further, the Electronic Toll Information Analyzer can calculate the payment that the Rental Vehicle Company owes the Third-Party Company because of the division of the usage fee.

It is also possible that the Customer has used Electronic Toll Collection without agreeing to pay the usage fee. The Electronic Toll Information Analyzer can determine “Unauthorized Use of Electronic Toll Collection in a Rental Car Information” because no Customer's rental period who agreed to pay the usage fees matches with the date of the tolls. This information can be transmitted to the Rental Vehicle Company so the Rental Vehicle Company can bill the Customer for these toll fees, along with any additional fees.

The Electronic Toll Information Analyzer can also determine “Rental Car Toll Violation Information” where the rental vehicle Customer goes through a tollgate without paying the toll. In these instances, the tollgate captures the rental vehicle's tag number. The Electronic Toll Information Collector can transmit Toll Violation Information to the Electronic Toll Information Analyzer. The Electronic Toll Information Analyzer can match the tag number of the violator with a database of a portion or all of the vehicle tag numbers of the vehicles of the Rental Vehicle Company to determine the Rental Car Toll Violation Information.

A benefit of using the Electronic Toll Information Analyzer is that it significantly reduces the amount of time of reporting a violation. A typical violation notice can take weeks or months to be communicated to the Rental Vehicle Company because the Toll Collector takes a long time in determining the owner of the vehicle because the Toll Collector must examine the entire database of the state from which the vehicle is registered. The Electronic Toll Information Analyzer of the preferred embodiments of the present invention can take less than a week, and preferably a couple of days, to report a violation to the Rental Vehicle Company. This allows the Rental Vehicle Company to quickly charge the Customer for this violation, along with any additional fees.

### EXAMPLE OF PREFERRED EMBODIMENTS OF THE PRESENT INVENTION

FIG. 2 is a flowchart showing an example of the preferred embodiments of the present invention. FIG. 2 shows a way in which the present invention can be implemented and is not intended to limit the present invention in any way. That is, the present invention can be practiced by modifying or omitting the steps shown in the flowchart of FIG. 2.

In step ST1, all the vehicle tag numbers of all the vehicles of a Rental Vehicle Company are registered with an Electronic Toll Collector. This ensures that the electronic toll use, including toll violations, of all the vehicles of the Rental Vehicle Company can be tracked. This step can be repeated as needed, for example, when the Rental Vehicle Company buys new vehicles. It should be understood that this step also includes un-registering vehicles, for example, if the vehicle is sold or is involved in an accident such that the vehicle can no longer be used.

In step ST1A, any discounts for electronic toll use are applied for. Some Electronic Toll Collectors provide discounts. For example, some Electronic Toll Collectors provide for volume discounts, sometime as much as 80%, and some Electronic Toll Collectors provide discounts for companion accounts maintained by other Electronic Toll Collectors. It is possible to apply for any suitable discount offered by an Electronic Toll Collector. This step can be repeated as needed, for example, when Electronic Toll Collectors offer new or change existing discounts. This step can be omitted.

In step ST2, Electronic Toll Device Information is registered with the Electronic Toll Collector. This allows the Customer's uses of the Electronic Toll Device to be tracked. This step can be repeated as needed, for example, when new Electronic Toll Devices are purchased. It should be understood that this step includes un-registering the Electronic Toll Devices with the Electronic Toll Collector, for example, when the Electronic Toll Device is lost, stolen, or damaged beyond use or repair.

In step ST3, Customer Information is collected. This step allows for the Customer to be identified so that the tolls incurred by the Customer can be associated with the Customer. This step can be repeated as needed.

In step ST3A, Customer's Electronic Toll Device, which is owned by the Customer and is registered with the Electronic Toll Collector for the Customer's vehicle, is registered with the Electronic Toll Collector for the rental vehicle. This step allows the Customer to properly use the Customer's Electronic Toll Device with the rental vehicle. This step can be repeated for any Customer who wishes to properly use the Customer's Electronic Toll Device with the rental vehicle. This step can be omitted.

In step ST4, Electronic Toll Information is collected from the Electronic Toll Collector. This step allows for the tolls incurred by the Customer to be associated with the Customer. This step can be repeated as needed, for example continuously, hourly, daily, or weekly.

In step ST5, Customer Information and Electronic Toll Information are compared. This step associates tolls incurred by a Customer with the Customer. This step determines if a violation has occurred or allows for the usage fee to be calculated. This step can be repeated as needed, for example, when new Electronic Toll Information or Customer information is collected.

In step ST6, it is determined if the vehicle tag number matches any vehicle that has a registered Electronic Toll Device. This step allows for the determination of toll violations. This step can be repeated, for example, when new Electronic Toll Information or Customer Information is collected.

In step ST7, after it has been determined that a toll violation has occurred (“NO” in step ST6), the Customer is charged for tolls incurred, a violation fee, and/or a violation processing fee. This step can be repeated, for example, when new toll violations occur.

In step ST8, after it has been determined that a toll violation has not occurred (“YES” in step ST6), it is determined if the Electronic Toll Device is the Customer's Electronic Toll Device. This step can be repeated, for example, when new tolls are incurred.

In step ST9, after it has been determined that the Electronic Toll Device is the Customer's Electronic Toll Device (“YES” in ST8), the Customer is only charged for tolls incurred. This step can be repeated, for example, when new tolls are incurred.

In step ST10, after it has been determined that the Electronic Toll Device is not the Customer's Electronic Toll Device (“NO” in ST8), the usage fee is calculated and charged to the Customer. This step can be repeated, for example, when new tolls are incurred.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A method of calculating a usage fee for the use of electronic toll collection in a rental vehicle, comprising:
collecting customer information concerning customer's renting of one or more rental vehicles;
collecting toll use information concerning the use of electronic toll collection at a tollgate;
calculating a usage fee based upon the customer information and the toll use information; and
displaying the usage fee.

2. A method according to claim 1, wherein the step of collecting customer information includes collecting at least one of a rental identification, an invoice number, a contract number, a unique vehicle identification, a vehicle identification number, a vehicle tag number, an electronic toll device number, a rental location, a rental date, a rental time, a rental length, a return date, and a return location.

3. A method according to claim 1, wherein the step of collecting toll use information includes collecting at least one of a posting date, a transaction date, a vehicle tag number, an electronic toll device number, a company name, a tollgate location, an entry tollgate, an entry date, an entry time, an exit tollgate, an exit date, an exit time, a payment plan, a vehicle class, and an amount of toll fee.

4. A method according to claim 1, wherein the step of calculating the usage fee includes matching a date of electronic toll use, which is collected during the step of collecting toll use information, with a date of a rental period, which is collected during the step of collecting customer information.

5. A method according to claim 1, wherein the step of calculating the usage fee is based upon at least one of a fixed daily rate, a per use fee, and a fixed fee per rental.

6. A method according to claim 1, wherein the usage fee is fixed.

7. A method according to claim 1, wherein the usage fee is variable.

8. A method according to claim 1, wherein the usage fee or a portion of the usage fee is paid to a rental vehicle company.

9. A method according to claim 1, wherein the usage fee or a portion of the usage fee is requested to be paid by a rental vehicle company.

10. A method according to claim 1, wherein the step of collecting customer information includes collecting an electronic toll device number of an electronic toll device; and
the electronic toll device is associated with one rental vehicle.

11. A method according to claim 1, wherein the step of collecting customer information includes collecting an electronic toll device number of an electronic toll device; and
the electronic toll device is associated with a plurality of rental vehicles.

12. A computer-readable medium storing a computer executable program for implementing the method of claim 1.

13. An analyzer arranged to implement the method of claim 1.

14. A method of determining rental car toll violation information, comprising the steps of:
collecting customer information concerning a customer's renting of one or more of a plurality of rental vehicles;
collecting toll violation information from a toll collector concerning toll violations of the plurality of rental vehicles;
determining rental car toll violation information by comparing toll violation information with the customer information; and
displaying the toll violation information.

15. A method according to claim 14, wherein the plurality of rental vehicles is all of the rental vehicles of a rental vehicle company.

16. A computer-readable medium storing a computer executable program for implementing the method of claim 14.

17. An analyzer arranged to implement the method of claim 14.

18. A method of determining unauthorized use of electronic toll collection in a rental vehicle information, comprising the steps of:
collecting customer information concerning customers renting of one or more of a plurality of rental vehicles;
collecting toll use information concerning toll use of the plurality of rental vehicles;
determining the unauthorized use of electronic toll collection in a rental vehicle information by comparing the toll use information with the customer information; and
displaying the unauthorized use of electronic toll collection in a rental vehicle information.

19. A computer-readable medium storing a computer executable program for implementing the method of claim 18.

20. An analyzer arranged to implement the method of claim 18.
